(19) United States
(12) Patent Application Publication
(10) Pub. No.: US 2003/0172586 A1
(43) Pub. Date: Sep. 18, 2003

(54) Plant wind screen, soil barrier, and water control apparatus

(76) Inventor: William H. Henderson, Santa Rosa, CA (US)

Correspondence Address: JOHNSON & STAINBROOK, LLP, Suite 203, 3550 Round Barn Blvd., Santa Rosa, CA, 95403, US

(21) Appl. No.: 10/388,801

(22) Filed: Mar. 13, 2003

Related U.S. Application Data
(60) Provisional application No. 60/364,673, filed on Mar. 13, 2002.

(51) Int. Cl. A01G 13/02

(52) U.S. Cl. 47/20.1

(57) ABSTRACT

A combination plant wind screen, soil erosion barrier, water control apparatus, having an annular base member having a lower edge and an upper edge, a partial frusto-conical shield member having with an upper border and a lower border. The shield member is connected to and upwardly disposed from the base member, tapers inwardly from its lower to upper border. A ring is connected to the said annular base member for anchoring the apparatus to the soil when installed around a plant. A lower annular member disposed downwardly from the annular base member and around the roots of a plant controls water drainage.

### CROSS REFERENCE TO RELATED APPLICATIONS

The present application claims the benefit of the filing date of U.S. Provisional Application Serial No. 60/364,673, filed Mar. 13, 2002.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to protective devices for young plants, and more particularly to a plant shield for plants planted on substantially level grade, and a soil barrier and water control apparatus when plants are planted on a slope.

### BACKGROUND INFORMATION AND DISCUSSION OF RELATED ART

It is known to provide protective barriers to shield seedlings from mechanical damage, as from wind, animals, insects, and hard rain. Illustrative of the more elaborate devices known in the art are those disclosed in the following United States patents.

U.S. Pat. No. 4,821,453 to Morehead discloses a plant protector that comprises a rigid, transparent cone that contains a fluid for absorbing thermal energy from an outside source and that releases that absorbed thermal energy at another time. The device is placed over a seedling plant after planting and protects the plant from frost and other adverse conditions until the plant becomes established. The fluid within the device may be drained onto the plant when the device is no longer needed.

U.S. Pat. No. 5,832,660 to Posa teaches a protective plant covering comprising a sheet of flexible material having two opposing side edges, each with a plurality of fasteners, such that, with the material wrapped around the plant, the two side edges may be adjustably fastened to one another and around the plant. The fasteners in the form of strings and capture devices are vertically spaced apart along one or both of the side edges in a manner which allows the material to at least partially overlap upon itself for enhanced protection. One or more fasteners may also be provided along the upper and lower edges of the material, to enable top and/or bottom closure mechanisms, or the ganging together of separate sheets to create a more extensive covering for larger plant varieties or groupings.

U.S. Pat. No. 6,282,835 to Richtsmeier shows a flexible plant protector with vertical tubes connected by an annular ring. The tubes may be filled with water or other fluids in order to protect a plant from damaging hot or cold temperatures. The invention extends the growing period of plants by artificially creating warmer days and warm nights in the plants' immediate environment, thereby triggering the plants to begin the growing season at a date earlier than the plants would otherwise begin their growing season. It also provides a measure of protection from wind, animals, and other mechanical stresses.

It is also known to provide simple wind screens, fencing, overhead coverings, and other structurally simple barriers to protect young plants from adverse conditions. However, no known device in the at provides a combination wind screen, soil barrier for hillside plantings, and water control apparatus for seedlings or other young plants.

### BRIEF SUMMARY OF THE INVENTION

It is therefore an object of the present invention to provide a combination wind screen, soil barrier, and water control apparatus for protecting young plants from mechanical stress and damage due to adverse conditions.

It is another object of the present invention to provide a lightweight stackable combination wind screen, soil barrier, and water control apparatus for protecting young plants.

It is yet another object of the invention to provide an apparatus that prevents minor hillside erosion from disturbing and damaging plants planted on hillside benches.

Yet another object of the present invention is to provide an apparatus for directing water drainage to the area immediately surrounding the roots of a seedling.

A still further object of the present invention is to provide an apparatus that contains drainage water within a defined area so as to minimize hillside soil erosion.

Yet another object of the present invention is to provide a wind screen that may be selectively positioned to maximize wind protection while minimizing the sun screening caused by such protection.

In a first preferred embodiment of the present invention, the combination plant wind screen, soil erosion barrier, and water control apparatus of the present invention comprises an annular base member having a lower edge and an upper edge and a partial frusto-conical shield member having an upper border and a lower border. The shield member is connected to and is upwardly disposed from the base member; preferably it tapers inwardly from its lower to upper border. Also, preferably, its lower border describes an arc of fewer degrees than its upper border. A ring may extend outwardly from the annular base member for anchoring the apparatus to the soil when installed around a plant.

In a second preferred embodiment, the apparatus includes a lower annular member integral with and extending downwardly from the annular base member for diverting water downwardly from the annular base member and around the roots of a plant.

In a third embodiment, the inventive apparatus includes means for holding a pest repellant container.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

FIG. 1 is a perspective view of the plant shield and water control apparatus of the present invention;

FIG. 2 is a side view in elevation showing the inventive apparatus used as a plant wind screen for a young plant growing on substantially level grade; and

FIG. 3 is a side view in elevation showing the inventive apparatus used as a soil barrier and water control for a plant growing on a hillside.

### DETAILED DESCRIPTION OF THE INVENTION

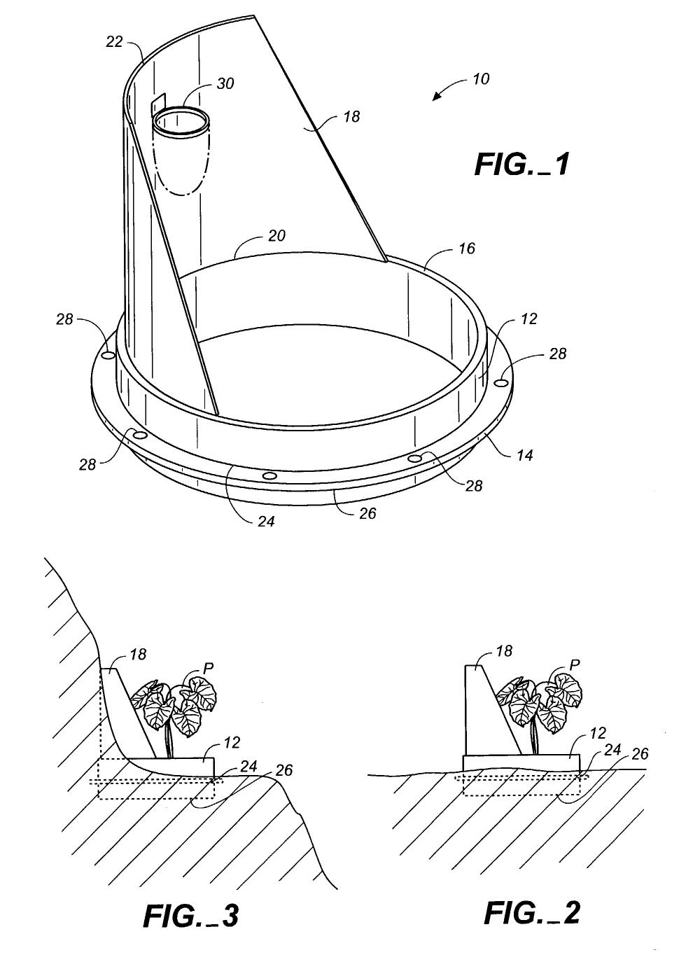

Referring to FIGS. 1-3, wherein like numerals represent like elements in the various views, the plant wind screen, soil barrier, and water control apparatus of the present invention, generally denominated 10, comprises an annular base member 12 having a lower edge 14 and an upper edge 16. Connected to the base member is a partial frusto-conical shield member 18. When the plant shield is employed in a typical setting, the shield member is vertically disposed from the upper edge of the annular base member. It includes an arcuate lower border 20 affixed to the upper edge of the annular base member 12, and an arcuate upper border 22. To facilitate stacking for shipping and storage, and to increase its own structural integrity, the shield member tapers inwardly from the lower border 20 to the upper border 22. Generally, and for most applications, the lower border of the shield member will describe an arc of less than 180 degrees. Neither the demands of wind abatement nor of water control call for a shield describing greater than 180 degrees at its lower border. In most cases, if not all, however, the taper requires that the lower border of the shield member describe an arc of fewer degrees than the upper border of the shield member.

To facilitate anchoring the apparatus in the soil, the apparatus includes soil anchoring means, preferably comprising a ring 24 either integral with the lower border of the annular base member or comprising a ledge or rim extending outwardly from the side of the annular base member itself. If formed as a ring, the ring is preferably buried in shallow soil immediately surrounding the stem of a plant, and the ring preferably turns or curls either upwardly or downwardly from the bottom edge to facilitate gripping of the soil and to resist pulling from the soil when the shield member is subjected to direct wind forces. In some instances, it may be desirable to bury the annular base member deeply around the stalk or stem of the plant. Stability in the soil, and water containment and diversion, may be facilitated by providing a lower annular member 26 integral with, and extending directly down from annular base member 12. Ring 24 is preferably broad enough to accommodate a plurality of holes 28 for accommodating nails or other soil fasteners passed through the holes and into the soil around the plant. In this manner, there are a number means provided to secure the inventive apparatus in the soil around a young plant, but to do so in a fashion that does not compromise soil integrity around root systems as the apparatus is removed when a plant has become established.

As will be readily appreciated, water drainage can be carefully tailored by including in the base member 12 and lower annual member 26 a plurality of drainage holes (not shown); this will facilitate the passage of water through the side of the base member in situations where water may pool or collect in compacted or dense clay soils. This may also be important when the device is used for hillside planting and it is desirable to avoid allowing substantial collections of water in the soil that might induce soil movement. It will also be appreciated that base member 12 selectively prevents water from collecting around the plant within the region defined by the base member. Thus low volume runoff will not inundate the plant with undesired water.

An optional element that may be included in the present invention comprises a detachable repellant holder or loop 30 (FIG. 3) that holds a removable perforated cannister or cylinder of pest repellant. The holder itself may be attached by any of a number of suitable means, including screwing into a threaded hole in the shield member or by forming the loop of outwardly biased tension members that engage slots in the shield. Optionally, the repellant may be contained within a capsule having a clip for attachment to the upper edge 22 of the shield member 18.

While in a first preferred embodiment the shield member 18 is integral with the annular base member 12, in a second preferred embodiment the shield member may include means for selective detachment from the base member. For instance, the lower border of the shield member may be fabricated with a continuous channel for coupling with the upper edge of the annular base member. Further, when so designed, the shield member may be selectively positioned around the upper border of the base member. Accordingly, even after the base member is sunk into soil, the position of the shield may be altered to protect young plant if prevailing wind directions change or if the direction from which intense sunlight comes changes. Moreover, the shield member is preferably fabricated from partially pliable thin plastic and will easily cut with conventional shears. Thus, a gardener can tailor the size and shape of the shield in the field to reduce protection if needed, or to closely fit the shield to the side of a slope.

As will be readily appreciated by reference to FIGS. 2 and 3, the inventive apparatus has two most general applications: First, the plant shield and water control apparatus of the present invention may be buried about the base of a plant in substantially level soil; second, the plant shield may be employed as a soil barrier and water control device when embedded in a hillside. In the latter application, a bench or substantially level section is cut into the hillside and the base member is sunk into the bench. If desired, the shield portion may be brought into proximity with the soil in the hillside itself and provides a backstop for water and minor soil erosion control. If not so positioned, some soil erosion may accumulate behind the shield. When situated on a hillside bench, the bench facilitates the collection of rainwater or irrigation water within the circumference of the annular base member, which then concentrates the water so that it drains down and through the root structure of the plant. If water pooling becomes a problem and threatens to induce soil movement, the base member may be modified to include drainage holes and/or slots. The collection and runoff of water can also be regulated by the depth to which the apparatus is buried around the plant. For instance, if more water collection is desired, a portion of the annular base member may be left above grade, thus allowing water to pool around the plant roots. If it is desired that water not be allowed to collect around the roots, the base member may be sunk to grade, or possibly even below grade.

In another aspect, the invention may be characterized as a combination plant wind screen, soil erosion barrier, water control apparatus, comprising an annular base member having a lower edge and an upper edge; a partial frusto-conical shield member having an upper border and a lower border, the shield member being connected to and upwardly disposed from the base member, and wherein the shield member tapers inwardly from its lower to upper border, and wherein its lower border describes an arc of fewer degrees than its upper border; a ring connected to the annular base member for anchoring the apparatus to the soil when installed around a plant; and a lower annular member integral with and extending downwardly from the annular base member for diverting water downwardly from the annular base member and around the roots of a plant.

In yet another aspect, the invention may be characterized as a method of protecting a seedling from wind and soil erosion, and for controlling water drainage around the seedling, said method comprising the steps of providing a combination plant wind screen, soil erosion barrier, and water control apparatus as described above, and installing the combination apparatus around an actual or potential stem of a young plant.

The inventive method may also be characterized as a method of protecting a seedling on a hillside slope from wind, soil erosion, and for controlling water drainage around the plant, comprising the steps of providing a combination plant wind screen, soil erosion barrier, water control apparatus as described above; cutting a generally level bench section into a hillside for planting seeds or seedling; sinking the base member of the combination apparatus into the bench section; and installing the combination apparatus in the soil around the seedling such that the shield portion is brought into general proximity with the soil in the hillside and so that the lower annular member is disposed beneath the ground surface around the seedling.

The foregoing disclosure is sufficient to enable one having skill in the art to practice the invention without undue experimentation, and provides the best mode of practicing the invention presently contemplated by the inventor. While there is provided herein a full and complete disclosure of the preferred embodiments of this invention, it is not intended to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A plant wind shield, soil erosion barrier, and water control apparatus, comprising:
an annular base member having a lower edge and an upper edge; and
a partial frusto-conical shield member having an upper border and a lower border, said shield member connected to, and upwardly disposed from, said annular base member.

2. The apparatus of claim 1, wherein said shield member is substantially vertically disposed from said upper edge of said annular base member.

3. The apparatus of claim 2, wherein said lower border of said shield member includes is affixed to said upper edge of said annular base member.

4. The apparatus of claim 1, wherein said shield member tapers inwardly from said lower border to said upper border.

5. The apparatus of claim 1, wherein said lower border of said shield member describes an arc of less than 180 degrees.

6. The apparatus of claim 1, wherein said lower border of said shield member describes an arc of fewer degrees than said upper border of said shield member.

7. The apparatus of claim 1, further including soil anchoring means.

8. The apparatus of claim 7, wherein said soil anchoring means comprises a ring connected to said annular base member.

9. The apparatus of claim 7, wherein said soil anchoring means comprises a rim extending outwardly from said annular base member.

10. The apparatus of claim 9, wherein said rim includes a curl to facilitate gripping of the soil when installed around a plant.

11. The apparatus of claim 10, wherein said rim includes a plurality of holes for accommodating soil fasteners.

12. The apparatus of claim 1, further including a lower annular member.

13. The apparatus of claim 12, wherein said lower annular member is integral with, and extends directly down from, said annular base member.

14. The apparatus of claim 1, further including a detachable pest repellant container holding means.

15. The apparatus of claim 14, wherein said pest repellant container holding means is a ring connected to said shield member.

16. The apparatus of claim 1, further including a clip on pest repellant container.

17. A combination plant wind screen, soil erosion barrier, water control apparatus, comprising:
an annular base member having a lower edge and an upper edge;
a partial frusto-conical shield member having an upper border and a lower border, said shield member connected to, upwardly disposed from said base member, wherein said shield member tapers inwardly from said lower border to said upper border, and wherein said lower border of said shield member describes an arc of fewer degrees than said upper border of said shield member;
a ring connected to said annular base member for anchoring said apparatus to the soil when installed around a plant; and
a lower annular member for diverting water downwardly from said annular base member and around the roots of a plant, said lower annular member integral with and extending downwardly from said annular base member.

18. A method of protecting a seedling from wind and soil erosion, and for controlling water drainage around the seedling, said method comprising the steps of:
providing a combination plant wind screen, soil erosion barrier, and water control apparatus as in claim 1; and
installing the combination apparatus around an actual or potential stem of a young plant.

19. A method of protecting a seedling on a hillside slope from wind, soil erosion, and for controlling water drainage around the plant, comprising the steps of:
providing a combination plant wind screen, soil erosion barrier, water control apparatus as in claim 17;
cutting a generally level bench section into a hillside for planting seeds or seedling;
sinking the base member of the combination apparatus into the bench section; and
installing the combination apparatus in the soil around the seedling such that the shield portion is brought into general proximity with the soil in the hillside and so that the lower annular member is disposed beneath the ground surface around the seedling.
